(19) United States
(12) Patent Application Publication
(10) Pub. No.: US 2025/0278784 A1
(43) Pub. Date: Sep. 4, 2025

(54) Method for Security Access to Power Internet of Things, Apparatus, Storage Medium and System

(71) Applicant: Zhongshan Power Supply Bureau of Guangdong Power Grid Co Ltd., Zhongshan City (CN)

(72) Inventors: Xiangfeng ZHOU, Zhongshan City (CN); Chunyuan CAI, Zhongshan City (CN); Yongjian LI, Zhongshan City (CN); Lifei LI, Zhongshan City (CN); Weixia JIAN, Zhongshan City (CN); Huibin ZHOU, Zhongshan City (CN); Hua LI, Zhongshan City (CN); Zhenjiang CHEN, Zhongshan City (CN); Ying ZHANG, Zhongshan City (CN); Yufeng CHEN, Zhongshan City (CN); Yanhe YIN, Zhongshan City (CN); Shaoyan JIANG, Zhongshan City (CN); Lei LIU, Zhongshan City (CN)

(73) Assignee: Zhongshan Power Supply Bureau of Guangdong Power Grid Co Ltd., Zhongshan City (CN)

(21) Appl. No.: 18/815,291

(22) Filed: Aug. 26, 2024

(30) Foreign Application Priority Data
Feb. 29, 2024 (CN) 202410229259.7

(51) Int. Cl. G06Q 40/04

(52) U.S. Cl. CPC G06Q 40/04

(57) ABSTRACT

A method for security access to power Internet of Things, an apparatus, a storage medium and a system are provided. According to the method, a first information gain value and a second information gain value are acquired by using a fuzzy set method; a first total information loss value, a second total information loss value and a third total information loss value are acquired; and a trust degree is determined according to the first information gain value, the second information gain value, the first total information loss value, the second total information loss value and the third total information loss value, and one of the following is executed according to a range where the trust degree is located: a first processing mode, a second processing mode and a third processing mode.

### CROSS-REFERENCE TO RELATED APPLICATION

The present disclosure claims priority to Chinese Patent Application No. 202410229259.7, filed with the China Patent Office on Feb. 29, 2024 and entitled “Method for Security Access to Power Internet of Things, Apparatus, Storage Medium and System”, the entire contents of which are incorporated herein by reference.

### TECHNICAL FIELD

The present disclosure relates to the technical field of Internet of Things, and in particular to a method for security access to power Internet of Things, an apparatus, a storage medium and a system.

### BACKGROUND

At present, data transmission requirements in a power grid mainly come from operation monitoring and control of various power devices, acquisition of power consumption information, scheduling of a power system, and the like. However, with the improvement of the requirements for more comprehensive deepening of distributed collection business and precise linkage of control business with the main network in the construction goal of power Internet of Things, as well as the proposal of new multi-level and multi-faceted requirements for the realization of comprehensive perception and analysis in conjunction with artificial intelligence and big data technology, strengthening of two-way interaction on the user side, and interconnecting and coordinating a variety of energy sources, the data flow information in the power Internet of Things are characterized by a more distinctive diversity, complexity, sea quantization and the like.

In current algorithms, the effect of controlling whether the generator sets are connected with the Internet of Things is poor due to the fact that the gain value and the loss value are not considered in the control of whether the generator sets are connected with the Internet of Things.

### SUMMARY

At least some embodiments of the present disclosure provide a method for security access to power Internet of Things, an apparatus, a storage medium and a system, so as to at least solve the problem that the effect of controlling whether the generator sets are connected with the Internet of Things is poor due to the fact that the gain value and the loss value are not considered in the control of whether the generator sets are connected with the Internet of Things in current algorithms.

In some embodiments of the present disclosure, a method for security access to power Internet of Things is provided, and the method is applied to the field of photovoltaic units and wind turbine generator sets, and the method includes that:
a first information gain value and a second information gain value are acquired by using a fuzzy set method, where the first information gain value is an information gain value, in a market trading, of the power Internet of Things affected by intermittency and variability of sunlight, and the second information gain value is an information gain value, in the market trading, of the power Internet of Things affected by intermittency and variability of wind energy;
a first total information loss value, a second total information loss value and a third total information loss value are acquired, where the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things, the second total information loss value is a total information loss value of the market trading caused by a collection error of the electricity quantity trading response quantity of the photovoltaic units and the wind turbine generator sets which participate in the market competition, and the third total information loss value is a total information loss value of the market trading caused by a collection error of the electricity quantity trading quotation of the photovoltaic units and the wind turbine generator sets which participate in the market competition; and
a trust degree is determined according to the first information gain value, the second information gain value, the first total information loss value, the second total information loss value, and the third total information loss value, and one of the following is executed according to a range where the trust degree is located: a first processing mode, a second processing mode and a third processing mode, where the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things.

Optionally, an operation of acquiring the first information gain value and the second information gain value by using the fuzzy set method includes that:
according to

$${R}_{RP 1} = E [ {⋁}_{i = 1}^{9} {k}_{Dvi} {v}_{Dvi} ⊗ {⋁}_{i = 1}^{9} {k}_{DSi} {S}_{Di} ⊗ {K}_{Mi} ( {M}_{PV} + {M}_{W} ) ]$$

$$- {k}_{G 1} {e}_{G 1} E [ ( {e}_{GPPV}^{t} + {e}_{GPW}^{t} ) ] ,$$

$${R}_{RP 2} = E [ {⋁}_{i = 1}^{9} {k}_{Dvi} {v}_{Dvi} ⊗ {⋁}_{i = 1}^{9} {k}_{DSi} {S}_{Di} ⊗ {K}_{Mi} ( {M}_{PV} + {M}_{W} ) ]$$

$$and - {k}_{G 2} {e}_{G 2} E [ ( {e}_{GPPV}^{t} + \text{?} ) ] ,$$

$$\text{?} \text{indicates text missing or illegible when filed}$$

the first information gain value and the second information gain value are determined;
where R_{RP1} is the first information gain value, R_{RP2} is the second information gain value,

$$\text{?} {k}_{Dvi} {v}_{Dvi}$$

$$\text{?} \text{indicates text missing or illegible when filed}$$

is an information gain value formed by providing a user with nine fuzzy uncertainty rates, containing extremely low, very low, low, lower, medium, higher, high, very high, and extremely high, for data transmission,

$$\text{?} {k}_{DSi} {S}_{Di}$$

$$\text{?} \text{indicates text missing or illegible when filed}$$

is an information gain value formed by providing the user with nine fuzzy uncertainty scales, containing extremely low, very low, low, lower, medium, higher, high, very high, and extremely high, for data storage sharing, k_{Mi}M_{PV} is an information gain value formed in response to the power Internet of Things providing data collection for the photovoltaic units at a sensing layer, k_{Mi}M_{W} is an information gain value formed in response to the power Internet of Things providing data collection for the wind turbine generator sets at the sensing layer, E[ ] is to obtain a desired value for [ ], k_{G1} and k_{G2} are respectively information effect coefficients brought about to the user due to power generation errors caused by the effects of intermittency and variability of sunlight and wind energy, e_{G1} and e_{G2} are respectively unit information gain values brought about to the user due to power generation errors caused by the effects of intermittency and variability of sunlight and wind energy, e_{GPPV}^{t} is a triangular fuzzy set of power generation errors of the photovoltaic units caused by uncertainties of sunlight and wind energy in a time period t, and e_{GPW}^{t} is a triangular fuzzy set of power generation errors of the wind turbine generator sets caused by uncertainties of sunlight and wind energy in the time period t, and

$$\text{?}$$

$$\text{?} \text{indicates text missing or illegible when filed}$$

represents a union set of 9 fuzzy sets.

Optionally, an operation of acquiring the first total information loss value includes that:
the first total information loss value is determined according to

$${L}_{R} = \text{?} ( \text{?} + \text{?} ) ;$$

$$\text{?} \text{indicates text missing or illegible when filed}$$

where L_{R} is the first total information loss value, Nₑ is the total number of time periods, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, eₚ^{t} is an error of the electricity quantity trading quotation of the photovoltaic units and the wind turbine generator sets which participate in the market competition, and eₚ^{t} is a quotation collection error of the photovoltaic units and the wind turbine generator sets which participate in the market competition.

Optionally, in a process of acquiring the second total information loss value, the method further includes that:
an information loss value of the market trading caused by the collection error of the electricity quantity trading response quantity of the photovoltaic units which participate in the market competition is determined according to

$${L}_{RPH} = \text{?} E [ \text{?} ] \times E [ \text{?} ] ,$$

$$\text{?} \text{indicates text missing or illegible when filed}$$

where Nₑ is the total number of time periods, L_{RPH} is an information loss value of the market trading caused by the collection error of the electricity quantity trading response quantity of the photovoltaic units which participate in the market competition, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, e_{RP}^{t} is a triangular fuzzy set of the collection error of an electricity quantity demand quantity in the time period t, e_{RPH}^{t} is a fuzzy number of the triangular fuzzy set of the collection error of the electricity quantity demand quantity of the photovoltaic units in the time period t, and E[ ] is to obtain a desired value for [ ].

Optionally, in a process of acquiring the third total information loss value, the method further includes that:
an information loss value of the market trading caused by the collection error of the electricity quantity trading quotation of the photovoltaic units which participate in the market competition is determined according to

$$\text{?} = \text{?} [ \text{?} ] \times E [ \text{?} ] ,$$

$$\text{?} \text{indicates text missing or illegible when filed}$$

where Nₑ is the total number of time periods, L_{RpH} is an information loss value of the market trading caused by the collection error of the electricity quantity trading quotation of the photovoltaic units which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, e_{Rp}^{t} is a triangular fuzzy set of a collection error of an energy market trading price in the time period t, e_{RpH}^{t} is a fuzzy number of the triangular fuzzy set of the collection error of the energy market trading price of the photovoltaic units in the time period t, and E[ ] is to obtain a desired value for [ ].

Optionally, an operation of executing one of the following according to the range where the trust degree is located: the first processing mode, the second processing mode and the third processing mode, includes that: in response to the trust degree being smaller than a first trust degree threshold, the third processing mode is executed; in response to the trust degree being greater than or equal to the first trust degree threshold and the trust degree being smaller than a second trust degree threshold, the second processing mode is executed; and in response to the trust degree being greater than or equal to the second trust degree threshold, the first processing mode is executed.

Optionally, an operation of determining the trust degree according to the first information gain value, the second information gain value, the first total information loss value, the second total information loss value, and the third total information loss value, includes that:
the trust degree is determined according to

$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$

where B₁ is the trust degree, R_{RP1} is the first information gain value, R_{RP2} is the second information gain value, L_{R} is the first total information loss value, L_{RP} is the second total information loss value, and L_{Rp} is the third total information loss value.

In some embodiments of the present disclosure, an apparatus for security access to power Internet of Things is further provided, and the apparatus is applied to the field of photovoltaic units and wind turbine generator sets, and the apparatus includes:
a first acquisition unit, arranged for acquiring a first information gain value and a second information gain value by using a fuzzy set method, where the first information gain value is an information gain value, in a market trading, of the power Internet of Things affected by intermittency and variability of sunlight, and the second information gain value is an information gain value, in the market trading, of the power Internet of Things affected by intermittency and variability of wind energy;
a second acquisition unit, arranged for acquiring a first total information loss value, a second total information loss value and a third total information loss value, where the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things, the second total information loss value is a total information loss value of the market trading caused by a collection error of the electricity quantity trading response quantity of the photovoltaic units and the wind turbine generator sets which participate in the market competition, and the third total information loss value is a total information loss value of the market trading caused by a collection error of the electricity quantity trading quotation of the photovoltaic units and the wind turbine generator sets which participate in the market competition; and
a processing unit, arranged for determining a trust degree according to the first information gain value, the second information gain value, the first total information loss value, the second total information loss value, and the third total information loss value, and executing one of the following according to a range where the trust degree is located: a first processing mode, a second processing mode and a third processing mode, where the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things.

In some embodiments of the present disclosure, a non-transitory storage medium is further provided, the non-transitory storage medium includes a program, where when the program runs, a device where the non-transitory storage medium is located is controlled to execute any one of the method for security access to power Internet of Things.

In some embodiments of the present disclosure, a system for security access to power Internet of Things is further provided, the system includes: at least one processor, a memory and at least one program, where the at least one program is stored in the memory and arranged for being executed by at least one processor, and at least one program includes computer instructions of any one of the method for security access to power Internet of Things.

Through applying the technical solution of the present disclosure, the power Internet of Things trust degree oriented to the market trading can be calculated and used as a criterion for Internet of Things security access control, and this method for security access control to the Internet of Things oriented to the distributed energy transaction can reflect the influence of the sensing system, the data transmission rate, and the data storage sharing at the same time, and can further provide a theoretical guidance for the evaluation of the power Internet of Things trust degree oriented to the market trading, and provide the necessary technical support for the market trading based on the Internet of Things. At the same time, due to the consideration of the gain value as well as the loss value, solves the problem that the effect of controlling whether the generator sets are connected with the Internet of Things is poor due to the fact that the gain value and the loss value are not considered in the control of whether the generator sets are connected with the Internet of Things in the current algorithms.

### BRIEF DESCRIPTION OF THE DRAWINGS

The accompanying drawings of the specification constituting a part of the present disclosure are used for providing a further understanding of the present disclosure, and the illustrative embodiments of the present disclosure and the description thereof are used for explaining the present disclosure, and do not constitute an improper limitation on the present disclosure. In the accompanying drawings:

FIG. 1 is a schematic flowchart of a method for security access to power Internet of Things according to some embodiments of the present disclosure;

FIG. 2 is a schematic flowchart of another method for security access to power Internet of Things according to some embodiments of the present disclosure; and

FIG. 3 is a structural block diagram of an apparatus for security access to power Internet of Things according to some embodiments of the present disclosure.

### DETAILED DESCRIPTION

It should be noted that, in the case of no conflict, the embodiments in the present disclosure and the features in the embodiments may be combined with each other. The present disclosure will be described in detail below with reference to the accompanying drawings and in combination with the embodiments.

In order to enable those skilled person in the art to better understand the solutions of the present disclosure, the technical solutions in the embodiments of the present disclosure will be clearly and completely described below with reference to the accompanying drawings in the embodiments of the present disclosure, and it is obvious that the described embodiments are a part of the embodiments of the present disclosure and not all of the embodiments. Based on the embodiments in the present disclosure, all other embodiments obtained by those skilled person in the art without making creative labor shall fall within the protection scope of this disclosure.

It should be noted that the terms “first”, “second” and so forth, in the description and claims of the present disclosure and in the above-mentioned drawings, are used for distinguishing between similar objects and not necessarily to describe a particular order or sequential order. It should be understood that the data used in this way may be interchanged where appropriate, such that the embodiments of the present disclosure described herein can be implemented in other sequences than those illustrated or described herein. In addition, terms “including”, “having”, and any variations thereof are intended to cover non-exclusive inclusions, for example, processes, methods, systems, products, or devices that contain a series of steps or units need not be limited to those explicitly listed steps or units, but may include other steps or units not explicitly listed or inherent to these processes, methods, products, or devices.

As introduced in the background, the effect of controlling whether the generator sets are connected with the Internet of Things is poor due to the fact that the gain value and the loss value are not considered in the control of whether the wind turbine generator sets and photovoltaic units are connected with the Internet of Things in current algorithms, and in order to solve the problem that the effect of controlling whether the generator sets are connected with the Internet of Things is poor due to the fact that the gain value and the loss value are not considered in the control of whether the generator sets are connected with the Internet of Things in the current algorithms, the embodiments of the present disclosure provide a method for security access to power Internet of Things, an apparatus, a storage medium, and a system.

The technical solutions in the embodiments of the present disclosure will be clearly and completely described below with reference to the accompanying drawings in the embodiments of the present disclosure.

In the present embodiment, a method for security access to power Internet of Things is provided, and it should be noted that the steps shown in the flowcharts of the accompanying drawings may be executed in a computer system such as a group of computer-executable instructions, and although a logical order is shown in the flowcharts, in some cases, the steps shown or described may be performed in an order different from that described herein.

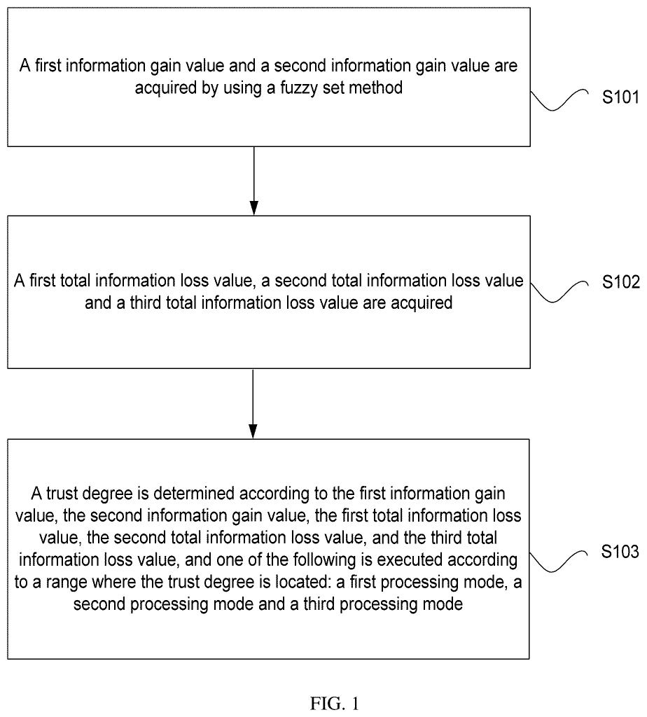

FIG. 1 is a schematic flowchart of a method for security access to power Internet of Things according to some embodiments of the present disclosure. As shown in FIG. 1, the method includes the following steps.

In step S101, a first information gain value and a second information gain value are acquired by using a fuzzy set method, where the first information gain value is an information gain value, in a market trading, of the power Internet of Things affected by intermittency and variability of sunlight, and the second information gain value is an information gain value, in the market trading, of the power Internet of Things affected by intermittency and variability of wind energy.

Specifically, the distributed energy market trading data collection error is evaluated. In a sensing layer of the power Internet of Things, related data information of an energy market trading price, an electricity quantity demand quantity, an electricity quantity trading response quantity and an electricity quantity trading quotation of photovoltaic units and wind turbine generator sets and the like with fuzzy uncertainty are acquired.

The Internet of Things sensing system is used for acquiring related data information of the electricity quantity trading response quantity of photovoltaic units and wind turbine generator sets which participate in market competition from the power market monitoring data center. According to the data of the electricity quantity trading response quantity of photovoltaic units and wind turbine generator sets which participate in market competition, a statistical analysis method is used for calculating triangular fuzzy sets of the collection error of the electricity quantity trading response quantity of photovoltaic units and wind turbine generator sets in a time period t (t=1,2, . . . , N_{RP}, N_{RP} is the total number of time periods):

$${e}_{RPPV}^{t} = ( {e}_{RPPV 1}^{t} , {e}_{RPPV 2}^{t} , {e}_{RPPV 3}^{t} ; {k}_{eRPPV}^{t} ) ;$$

$${e}_{RPW}^{t} = ( {e}_{RPW 1}^{t} , {e}_{RPW 2}^{t} , {e}_{RPW 3}^{t} ; {k}_{eRPW}^{t} ) ;$$

where E_{RPPV}^{t} and k_{eRPPV}^{t} are respectively a triangular fuzzy set and a membership coefficient of the collection error of the electricity quantity trading response quantity of photovoltaic units in the time period t, e_{RPW}^{t} and k_{eRPW}^{t} are respectively a triangular fuzzy set and a membership coefficient of the collection error of the electricity quantity trading response quantity of wind turbine generator sets in the time period t, e_{RPPVj}^{t} and e_{RPWj}^{t} (j=1, 2, 3) are respectively the fuzzy numbers of the triangular fuzzy sets of the collection error of the electricity quantity trading response quantity of photovoltaic units and wind turbine generator sets in the time period t.

The Internet of Things sensing system is used for acquiring related data information of the quotation of photovoltaic units and wind turbine generator sets from the power market monitoring data center. According to the data of the quotation of photovoltaic units and wind turbine generator sets, a statistical analysis method is used for calculating triangular fuzzy sets of the collection error of the quotation of photovoltaic units and wind turbine generator sets in the time period t (t=1, 2, . . . , N_{RP}, N_{RP} is the total number of time periods):

$${e}_{GPPV}^{t} = ( {e}_{GPPV 1}^{t} , {e}_{GPPV 2}^{t} , {e}_{GPPV 3}^{t} ; {k}_{eGPPV}^{t} ) ;$$

$${e}_{GPW}^{t} = ( {e}_{GPW 1}^{t} , {e}_{GPW 2}^{t} , {e}_{GPW 3}^{t} ; {k}_{eGPW}^{t} ) ;$$

where e_{GPPV}^{t} and k_{eGPPV}^{t} are respectively a triangular fuzzy set and a membership coefficient of the power generation error of photovoltaic units caused by sunshine and wind energy uncertainty in the time period t, e_{GPW}^{t} and k_{eGPW}^{t} are respectively a triangular fuzzy set and a membership coefficient of the power generation error of wind turbine generator sets caused by sunshine and wind energy uncertainty in the time period t, e_{GPPVj}^{t} and e_{GPWj}^{t} (j=1, 2, 3) are respectively the fuzzy numbers of the triangular fuzzy sets of the power generation error of photovoltaic units and wind turbine generator sets caused by sunshine and wind energy uncertainty in the time period t.

The Internet of Things sensing system is used for acquiring related data information of the quotation of photovoltaic units and wind turbine generator sets from the power market monitoring data center. According to the data of the quotation of photovoltaic units and wind turbine generator sets, a statistical analysis method is used for calculating triangular fuzzy sets of the collection error of the quotation of photovoltaic units and wind turbine generator sets in the time period t:

$${e}_{RpPV}^{t} = ( {e}_{RpPV 1}^{t} , {e}_{RpPV 2}^{t} , {e}_{RpPV 3}^{t} ; {k}_{eRpPV}^{t} ) ;$$

$${e}_{RpW}^{t} = ( {e}_{RpW 1}^{t} , {e}_{RpW 2}^{t} , {e}_{RpW 3}^{t} ; {k}_{eRpW}^{t} ) ;$$

where e_{RpPV}^{t} and k_{eRpPV}^{t} are respectively a triangular fuzzy set and a membership coefficient of the collection error of the quotation of photovoltaic units in the time period t, e_{RpW}^{t} and k_{eRpW}^{t} are respectively a triangular fuzzy set and a membership coefficient of the collection error of the quotation of wind turbine generator sets in the time period t, e_{RpPVj}^{t} and e_{RpWj}^{t} (j=1, 2, 3) are respectively the fuzzy numbers of the triangular fuzzy sets of the collection error of the quotation of photovoltaic units and wind turbine generator sets in the time period t.

The Internet of Things sensing system is used for acquiring related data information of energy market trading price from the power market monitoring data center. According to the data of energy market trading price, a statistical analysis method is used for calculating triangular fuzzy sets of the collection error of energy market trading price in the time period t:

$${e}_{Rp}^{t} = ( {e}_{Rp 1}^{t} , {e}_{Rp 2}^{t} , {e}_{Rp 3}^{t} ; {k}_{eRp}^{t} ) ;$$

where e_{Rp}^{t} and k_{eRp}^{t} are respectively a triangular fuzzy set and a membership coefficient of the collection error of energy market trading price in the time period t, e_{Rpj}^{t} (j=1, 2, 3) is the fuzzy numbers of the triangular fuzzy sets of the collection error of energy market trading price in the time period t.

The Internet of Things sensing system is used for acquiring related data information of electricity quantity demand quantity from the power market monitoring data center. According to the data of electricity quantity demand quantity of electricity market, a statistical analysis method is used for calculating triangular fuzzy sets of the collection error of electricity quantity demand quantity in the time period t:

$${e}_{RP}^{t} = ( {e}_{RP 1}^{t} , {e}_{RP 2}^{t} , {e}_{RP 3}^{t} ; {k}_{eRP}^{t} ) ;$$

where e_{RP}^{t} and k_{eRP}^{t} are respectively a triangular fuzzy set and a membership coefficient of the collection error of electricity quantity demand quantity in the time period t, e_{RPj}^{t} (j=1, 2, 3) is the fuzzy numbers of the triangular fuzzy sets of the collection error of electricity quantity demand quantity in the time period t.

Power Internet of Things data transmission rate for distributed energy market trading is monitored. At a network layer of the power Internet of Things, the related data information of the data transmission rate is obtained from the Internet of Things monitoring data center, and a statistical analysis method is used for calculating and determining nine triangular fuzzy sets v_{Di} (i=1,2, . . . , 9) of fuzzy uncertainty with the data transmission rates containing extremely low, very low, low, lower, medium, higher, high, very high and extremely high:

$${v}_{Di} = ( {v}_{Di 1} , {v}_{Di 2} , {v}_{Di 3} ; {k}_{Dvi} ) ;$$

where v_{Di} is a triangular fuzzy set with i^{th} data transmission rate, v_{D/1}, v_{D/2}, v_{D/3} and k_{D/4} are respectively triangular fuzzy sets and a membership coefficient of the triangular fuzzy set with i^{th} data transmission rate.

Power Internet of Things data storage sharing scale for distributed energy market trading is evaluated. At a platform layer of the power Internet of Things, the related data information of the data storage sharing scale is obtained from the Internet of Things monitoring data center, and a statistical analysis method is used for calculating and determining nine triangular fuzzy sets S_{Di} (i=1,2, . . . , 9) of fuzzy uncertainty with the data storage sharing scale containing extremely low, very low, low, lower, medium, higher, high, very high and extremely high:

$${S}_{Di} = ( {S}_{Di 1} , {S}_{Di 2} , {S}_{Di 3} ; {k}_{DSiL} ) ;$$

where S_{Di} is a triangular fuzzy set with i^{th} data storage sharing scale, S_{D/1}, S_{D/2}, S_{D/3} and l_{DS/L} are respectively triangular fuzzy sets and a membership coefficient of the triangular fuzzy set with i^{th} data storage sharing scale.

Collection errors, formed in power Internet of Things, of an electricity quantity trading response quantity of photovoltaic units and wind turbine generator sets which participate in market competition are jointly determined according to collection errors of electric power consumption demand and output power of various generator sets. The collection error of the output power of each generator set includes the collection error of the output power of the photovoltaic power generation system participating in the market competition, the collection error of the output power of the wind turbine generator sets participating in the market competition, and the power generation error caused by sunlight and wind energy uncertainty. Therefore, the collection error e_{P}^{t}, formed in power Internet of Things, of an electricity quantity trading response quantity of photovoltaic units and wind turbine generator sets which participate in market competition is calculated according to the following formula:

$${e}_{P}^{t} = E [ {e}_{RP}^{t} ⊗ ( {e}_{RPPV}^{t} + {e}_{RPW}^{t} ) ⊗ ( {e}_{GPPV}^{t} + {e}_{GPW}^{t} ) ] ;$$

where ⊗ represents a union set of fuzzy sets.

Collection errors, formed in power Internet of Things, of quotation of generator sets which participate in market competition are jointly determined according to collection errors of the energy market trading price and quotation of various generator sets. The collection error of quotation of various generator sets includes the collection error of the quotation of the photovoltaic power generation system participating in market competition, the collection error of the quotation of the wind turbine generator sets participating in market competition, the collection error of the quotation of the nuclear power units participating in market competition, and the collection error of the quotation of the gas turbine generator sets participating in market competition. Therefore, the collection error e_{P}^{t}, formed in power Internet of Things, of quotation of photovoltaic units and wind turbine generator sets which participate in market competition is calculated according to the following formula:

$${e}_{p}^{t} = E [ {e}_{Rp}^{t} ⊗ ( {e}_{RpPV}^{t} + {e}_{RpW}^{t} ) ⊗ ( {e}_{GPPV}^{t} + {e}_{GPW}^{t} ) ] .$$

In step S101, the first information gain value and the second information gain value are acquired by using the fuzzy set method. That is, at the sensing layer, data information of power market electricity price, electric power consumption demand, the quotation of the electric power consumption demand, output power of various generator sets and the quotation of various generator sets are obtained by means of a sensing system. At the platform layer, with the help of a big data system, the sharing and interaction of power system generation data can be realized. At the network layer, with the help of the network system, the transmission of data can be realized, so that the power generator can obtain sufficient information by using the Internet of Things to obtain benefits, and the information gain value of the power Internet of Things in the market trading considering the influence of intermittency and variability of sunlight and wind energy is calculated according to the following formula:
according to

$${R}_{RP 1} = E [ {{∨}^{9}}_{i = 1} {k}_{Dvi} {v}_{Dvi} ⊗ {{∨}^{9}}_{i = 1} {k}_{DSi} {S}_{Di} ⊗ {k}_{Mi} ( {M}_{PV} + {M}_{W} ) ]$$

$$- {k}_{G 1} {e}_{G 1} E [ ( {e}_{GPPV}^{t} + {e}_{GPW}^{t} ) ] ,$$

$${R}_{RP 2} = E [ {{∨}^{9}}_{i = 1} {k}_{Dvi} {v}_{Dvi} ⊗ {{∨}^{9}}_{i = 1} {k}_{DSi} {S}_{Di} ⊗ {k}_{Mi} ( {M}_{PV} + {M}_{W} ) ]$$

$$and$$

$$- {k}_{G 2} {e}_{G 2} E [ ( {e}_{GPPV}^{t} + {e}_{GPW}^{t} ) ] ,$$

the first information gain value and the second information gain value are determined;
where R_{RP1} is the first information gain value, R_{RP2} is the second information gain value,

$${{∨}^{9}}_{i = 1} {k}_{Dvi} {v}_{Dvi}$$

is an information gain value formed by providing a user with nine fuzzy uncertainty rates, containing extremely low, very low, low, lower, medium, higher, high, very high, and extremely high, for data transmission,

$${{∨}^{9}}_{i = 1} {k}_{DSi} {S}_{Di}$$

is an information gain value formed by providing the user with nine fuzzy uncertainty scales, containing extremely low, very low, low, lower, medium, higher, high, very high, and extremely high, for data storage sharing, k_{Mi}M_{PV} is an information gain value formed in response to the power Internet of Things providing data collection for the photovoltaic units at a sensing layer, k_{Mi}M_{W} is an information gain value formed in response to the power Internet of Things providing data collection for the wind turbine generator sets at the sensing layer, E[ ] is to obtain a desired value for [ ], k_{G1} and for k_{G2} are respectively information effect coefficients brought about to the user due to power generation errors caused by the effects of intermittency and variability of sunlight and wind energy, e_{G1} and e_{G2} are respectively unit information gain values brought about to the user due to power generation errors caused by the effects of intermittency and variability of sunlight and wind energy, Carry is a triangular fuzzy set of power generation errors of the photovoltaic units caused by uncertainties of sunlight and wind energy in a time period t, and e_{GPW}^{t} is a triangular fuzzy set of power generation errors of the wind turbine generator sets caused by uncertainties of sunlight and wind energy in the time period t, and

$${{∨}^{9}}_{i = 1}$$

represents a union set of 9 fuzzy sets.

In addition, according to: M_{PV}=(M_{PV1}, M_{PV2}, M_{PV3}; k_{PV});
and M_{W}=(M_{W1}, M_{W2}, M_{W3}; k_{W});
M_{PV} and M_{W} are obtained. In the formula, M_{PV} is a triangular fuzzy set of a data acquisition scale provided by the power Internet of Things in the sensing layer for photovoltaic units, M_{PV1}, M_{PV2}, M_{PV3} and k_{PV} are fuzzy sets and a membership coefficient of a triangular fuzzy set of a data acquisition scale provided by the power Internet of Things in the sensing layer for photovoltaic units, M_{W} is a triangular fuzzy set of a data acquisition scale provided by the power Internet of Things in the sensing layer for wind turbine generator sets, M_{W1}, M_{W2}, M_{W3} and k_{W} are fuzzy sets and a membership coefficient of a triangular fuzzy set of a data acquisition scale provided by the power Internet of Things in the sensing layer for wind turbine generator sets.

In step S102, a first total information loss value, a second total information loss value and a third total information loss value are acquired, where the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things, the second total information loss value is a total information loss value of the market trading caused by a collection error of the electricity quantity trading response quantity of the photovoltaic units and the wind turbine generator sets which participate in the market competition, and the third total information loss value is a total information loss value of the market trading caused by a collection error of the electricity quantity trading quotation of the photovoltaic units and the wind turbine generator sets which participate in the market competition.

In step S102, an operation of acquiring the first total information loss value includes that:
the first total information loss value is determined according to

$${L}_{R} = {\sum }_{t = 1}^{{N}_{e}} ( {k}_{PW}^{t} {k}_{Pi}^{t} {e}_{P}^{t} + {k}_{pW}^{t} {k}_{pi}^{t} {e}_{p}^{t} ) ;$$

where L_{R} is the first total information loss value, Nₑ is the total number of time periods, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, k_{pW}^{t} is a weight coefficient of a quotation collection error of the photovoltaic units and the wind turbine generator sets which participate in the market competition, kₚₜ^{t} is a unit loss value of the electricity quantity trading quotation of the photovoltaic units and the wind turbine generator sets which participate in the market competition, e_{P}^{t} is an error of the electricity quantity trading quotation of the photovoltaic units and the wind turbine generator sets which participate in the market competition, and eₚ^{t} is a quotation collection error of the photovoltaic units and the wind turbine generator sets which participate in the market competition.

In step S102, in the process of acquiring the second total information loss value, the method further includes that:
an information loss value of the market trading caused by the collection error of the electricity quantity trading response quantity of the photovoltaic units which participate in the market competition is determined according to

$${L}_{RPH} = {\sum }_{t = 1}^{{N}_{e}} {k}_{PW}^{t} {k}_{PI}^{t} E [ {e}_{RP}^{t} ] \times E [ {e}_{RPH}^{t} ] ,$$

where Nₑ is the total number of time periods, L_{RPH} is an information loss value of the market trading caused by the collection error of the electricity quantity trading response quantity of the photovoltaic units which participate in the market competition, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, e_{RP}^{t} is a triangular fuzzy set of the collection error of an electricity quantity demand quantity in the time period t, e_{RPH}^{t} is a fuzzy number of the triangular fuzzy set of the collection error of the electricity quantity demand quantity of the photovoltaic units in the time period t, and E[ ] is to obtain a desired value for [ ].

Specifically, for the wind turbine generator sets:
an information loss value of the market trading caused by the collection error of the electricity quantity trading response quantity of the wind turbine generator sets which participate in the market competition is determined according to

$${L}_{RPI} = {\sum }_{t = 1}^{{N}_{e}} {k}_{PW}^{t} {k}_{PI}^{t} E [ {e}_{RP}^{t} ] \times E [ {e}_{RPG}^{t} ] .$$

where L_{RPT} is an information loss value of the market trading caused by the collection error of the electricity quantity trading response quantity of the wind turbine generator sets which participate in the market competition, e_{RPG}^{t} is a fuzzy number of the triangular fuzzy set of the collection error of the electricity quantity demand quantity of the wind turbine generator sets in the time period t.

The second total information loss value is a sum value of L_{RPH} and L_{RPT}.

In step S102, in the process of acquiring the third total information loss value, the method further includes that:
an information loss value of the market trading caused by the collection error of the electricity quantity trading response quantity of the photovoltaic units which participate in the market competition is determined according to

$${L}_{RPH} = {\sum }_{t = 1}^{{N}_{e}} {k}_{PW}^{t} {k}_{PI}^{t} E [ {e}_{RP}^{t} ] \times E [ {e}_{RPH}^{t} ] ,$$

where Nₑ is the total number of time periods, L_{RPH} is an information loss value of the market trading caused by the collection error of the electricity quantity trading response quantity of the photovoltaic units which participate in the market competition, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, e_{RP}^{t} is a triangular fuzzy set of the collection error of an electricity quantity demand quantity in the time period t, e_{RPH}^{t} is a fuzzy number of the triangular fuzzy set of the collection error of the electricity quantity demand quantity of the photovoltaic units in the time period t, and E[ ] is to obtain a desired value for [ ].

Specifically, for the wind turbine generator sets:
an information loss value of the market trading caused by the collection error of the electricity quantity trading quotation of the wind turbine generator sets which participate in the market competition is determined according to

$${L}_{{R}_{p} T} = {\sum }_{t = 1}^{{N}_{e}} {k}_{ρ W}^{t} {k}_{pl}^{t} E [ {e}_{Rp}^{t} ] \times E [ {e}_{RpG}^{t} ] ,$$

where L_{RpT} is an information loss value of the market trading caused by the collection error of the electricity quantity trading quotation of the wind turbine generator sets which participate in the market competition, e_{RpG}^{t} is a fuzzy number of the triangular fuzzy set of the collection error of the energy market trading price of the wind turbine generator sets in the time period t.

The third total information loss value is a sum value of L_{RpH} and L_{RpT}.

In step S103, a trust degree is determined according to the first information gain value, the second information gain value, the first total information loss value, the second total information loss value, and the third total information loss value, and one of the following is executed according to a range where the trust degree is located: a first processing mode, a second processing mode and a third processing mode, where the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things.

In the above steps, the power Internet of Things trust degree oriented to the market trading can be calculated and used as a criterion for Internet of Things security access control, and this method for security access control to the Internet of Things oriented to the distributed energy transaction can reflect the influence of the sensing system, the data transmission rate, and the data storage sharing at the same time, and can further provide a theoretical guidance for the evaluation of the power Internet of Things trust degree oriented to the market trading, and provide the necessary technical support for the market trading based on the Internet of Things. At the same time, due to the consideration of the gain value as well as the loss value, solves the problem that the effect of controlling whether the generator sets are connected with the Internet of Things is poor due to the fact that the gain value and the loss value are not considered in the control of whether the generator sets are connected with the Internet of Things in the current algorithms.

In some embodiments of the present disclosure, one of the following is executed according to the range where the trust degree is located: the first processing mode, the second processing mode and the third processing mode. In response to the trust degree being smaller than a first trust degree threshold (such as 0.3), the third processing mode is executed. In response to the trust degree being greater than or equal to the first trust degree threshold and the trust degree is smaller than a second trust degree threshold (such as 0.5), the second processing mode is executed. In response to the trust degree being greater than or equal to the second trust degree threshold, the first processing mode is executed.

When the trust degree is greater than or equal to 0.5 and the trust degree is smaller than 1, the photovoltaic units and the wind turbine generator sets are allowed to access the power Internet of Things. When the trust degree is greater than or equal to 0.3 and the trust degree is smaller than 0.5, the photovoltaic units or the wind turbine generator sets are allowed to access the power Internet of Things. When the trust degree is greater than or equal to 0 and the trust degree is smaller than 0.3, the photovoltaic units and the wind turbine generator sets are prohibited from accessing the power Internet of Things.

In some embodiments of the present disclosure, an operation of determining the trust degree according to the first information gain value, the second information gain value, the first total information loss value, the second total information loss value, and the third total information loss value, includes the following steps.

The trust degree is determined according to

$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$

where Bᵢ is the trust degree, R_{RP1} is the first information gain value, R_{RP2} is the second information gain value, L_{R} is the first total information loss value, L_{RP} is the second total information loss value, and L_{Rp} is the third total information loss value.

In the power Internet of Things oriented to power system market trading, information provided by users of the perception layer, network layer and platform layer leads to user benefits.

In order to enable a person skilled in the art to understand the technical solutions of the present disclosure more clearly, an implementation process of the method for security access to power Internet of Things of the present disclosure will be described in detail below with reference to specific embodiments.

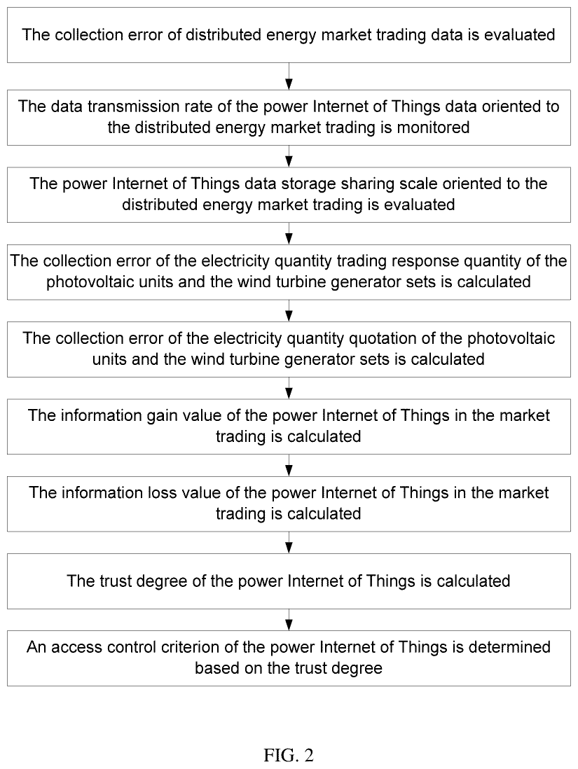

This embodiment relates to the method for security access to power Internet of Things as shown in FIG. 2, including the following steps.

In step S1: the collection error of distributed energy market trading data is evaluated.

In step S2: the data transmission rate of the power Internet of Things data oriented to the distributed energy market trading is monitored.

In step S3: the power Internet of Things data storage sharing scale oriented to the distributed energy market trading is evaluated.

In step S4: the collection error of the electricity quantity trading response quantity of the photovoltaic units and the wind turbine generator sets is calculated.

In step S5: the collection error of the electricity quantity quotation of the photovoltaic units and the wind turbine generator sets is calculated.

In step S6: the information gain value of the power Internet of Things in the market trading is calculated.

In step S7: the information loss value of the power Internet of Things in the market trading is calculated.

In step S8: the trust degree of the power Internet of Things is calculated.

In step S9: an access control criterion of the power Internet of Things is determined based on the trust degree.

It should be noted that the steps shown in the flowcharts of the accompanying drawings may be executed in a computer system such as a group of computer-executable instructions, and although a logical order is shown in the flowcharts, in some cases, the steps shown or described may be performed in an order different from that described herein.

Embodiments of the present disclosure further provide an apparatus for security access to power Internet of Things, and it should be noted that the apparatus for security access to power Internet of Things in the embodiments of present disclosure is arranged for performing the method for security access to power Internet of Things provided in the embodiments of present disclosure. The apparatus is arranged for implementing the foregoing embodiments and exemplary implementations, and details are not described again. As used below, the term “module” may be a combination of software and hardware, or a combination of software or hardware, that implements a predetermined function. Although the apparatus described in the following embodiments is exemplarily implemented in software, implementation of hardware or a combination of software and hardware is also possible and conceived.

The following describes an apparatus for security access to power Internet of Things provided in some embodiments of present disclosure.

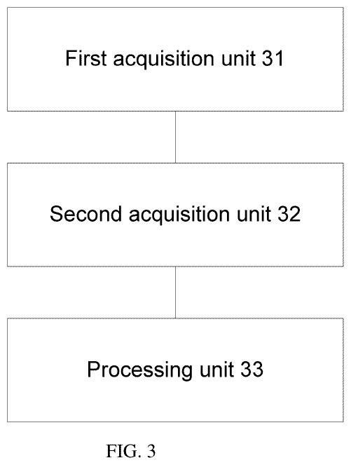

FIG. 3 is a structural block diagram of an apparatus for security access to power Internet of Things according to some embodiments of present disclosure. As shown in FIG. 3, the apparatus includes:
a first acquisition unit 31, arranged for acquiring a first information gain value and a second information gain value by using a fuzzy set method, where the first information gain value is an information gain value, in a market trading, of the power Internet of Things affected by intermittency and variability of sunlight, and the second information gain value is an information gain value, in the market trading, of the power Internet of Things affected by intermittency and variability of wind energy;
a second acquisition unit 32, arranged for acquiring a first total information loss value, a second total information loss value and a third total information loss value, where the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things, the second total information loss value is a total information loss value of the market trading caused by a collection error of the electricity quantity trading response quantity of the photovoltaic units and the wind turbine generator sets which participate in the market competition, and the third total information loss value is a total information loss value of the market trading caused by a collection error of the electricity quantity trading quotation of the photovoltaic units and the wind turbine generator sets which participate in the market competition; and
a processing unit 33, arranged for determining a trust degree according to the first information gain value, the second information gain value, the first total information loss value, the second total information loss value, and the third total information loss value, and executing one of the following according to a range where the trust degree is located: a first processing mode, a second processing mode and a third processing mode, where the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things.

In the above apparatus, the power Internet of Things trust degree oriented to the market trading can be calculated and used as a criterion for Internet of Things security access control, and this method for security access control to the Internet of Things oriented to the distributed energy transaction can reflect the influence of the sensing system, the data transmission rate, and the data storage sharing at the same time, and can further provide a theoretical guidance for the evaluation of the power Internet of Things trust degree oriented to the market trading, and provide the necessary technical support for the market trading based on the Internet of Things. At the same time, due to the consideration of the gain value as well as the loss value, solves the problem that the effect of controlling whether the generator sets are connected with the Internet of Things is poor due to the fact that the gain value and the loss value are not considered in the control of whether the generator sets are connected with the Internet of Things in the current algorithms.

In some embodiments of present disclosure, the first acquisition unit includes a first determining module.

The first determining module is arranged for determining the first information gain value and the second information gain value according to

$${R}_{RP 1} = E [ {⋁}_{i = 1}^{9} {k}_{Dvi} {v}_{Dvi} ⊗ {⋁}_{i = 1}^{9} {k}_{Dsi} {S}_{Di} ⊗ {k}_{Mi} ( {M}_{PV} + {M}_{W} ) ] \\ - {k}_{G 1} {e}_{G 1} E [ ( {e}_{GPPV}^{t} + {e}_{GPW}^{t} ) ] , \\ {R}_{RP 2} = E [ {⋁}_{i = 1}^{9} {k}_{Dvi} {v}_{Dvi} ⊗ {⋁}_{i = 1}^{9} {k}_{Dsi} {S}_{Di} ⊗ {k}_{Mi} ( {M}_{PV} + {M}_{W} ) ]$$

$$and - {k}_{G 2} {e}_{G 2} E [ ( {e}_{GPPV}^{t} + {e}_{GPW}^{t} ) ] ;$$

where R_{RP1} is the first information gain value, R_{RP2} is the second information gain value,

$${⋁}_{i = 1}^{9} {k}_{Dvi} {v}_{Dvi}$$

is an information gain value formed by providing a user with nine fuzzy uncertainty rates, containing extremely low, very low, low, lower, medium, higher, high, very high, and extremely high, for data transmission,

$${⋁}_{i = 1}^{9} {k}_{Dsi} {S}_{Di}$$

is an information gain value formed by providing the user with nine fuzzy uncertainty scales, containing extremely low, very low, low, lower, medium, higher, high, very high, and extremely high, for data storage sharing, k_{Mi}M_{PV} is an information gain value formed in response to the power Internet of Things providing data collection for the photovoltaic units at a sensing layer, k_{Mi}M_{W} is an information gain value formed in response to the power Internet of Things providing data collection for the wind turbine generator sets at the sensing layer, E[ ] is to obtain a desired value for [ ], k_{G1} and k_{G2} are respectively information effect coefficients brought about to the user due to power generation errors caused by the effects of intermittency and variability of sunlight and wind energy, e_{G1} and e_{G2} are respectively unit information gain values brought about to the user due to power generation errors caused by the effects of intermittency and variability of sunlight and wind energy, e_{GPPV}^{t} is a triangular fuzzy set of power generation errors of the photovoltaic units caused by uncertainties of sunlight and wind energy in a time period t, and e_{GPW}^{t} is a triangular fuzzy set of power generation errors of the wind turbine generator sets caused by uncertainties of sunlight and wind energy in the time period t, and

$${⋁}_{i = 1}^{9}$$

represents a union set of 9 fuzzy sets.

In some embodiments of present disclosure, the second acquisition unit includes a second determining module.

The second determining module is arranged for determining the first total information loss value according to

$${L}_{R} = {\sum }_{t = 1}^{{N}_{e}} ( {k}_{PW}^{t} {k}_{PI}^{t} {e}_{P}^{t} + {k}_{p W}^{t} {k}_{pI}^{t} {e}_{p}^{t} ) ;$$

where L_{R} is the first total information loss value, Nₑ is the total number of time periods, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, e_{P}^{t} is an error of the electricity quantity trading quotation of the photovoltaic units and the wind turbine generator sets which participate in the market competition, and eₚ^{t} is a quotation collection error of the photovoltaic units and the wind turbine generator sets which participate in the market competition.

In some embodiments of present disclosure, the second acquisition unit includes a third determining module. In the process of acquiring the second total information loss value, the third determining module is arranged for determining an information loss value of the market trading caused by the collection error of the electricity quantity trading response quantity of the photovoltaic units which participate in the market competition according to

$${L}_{RPH} = {\sum }_{t = 1}^{{N}_{e}} {k}_{PW}^{t} {k}_{PI}^{t} E [ {e}_{RP}^{t} ] \times E [ {e}_{RPH}^{t} ] ,$$

where Nₑ is the total number of time periods, L_{RPH} is an information loss value of the market trading caused by the collection error of the electricity quantity trading response quantity of the photovoltaic units which participate in the market competition, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, e_{RP}^{t} is a triangular fuzzy set of the collection error of an electricity quantity demand quantity in the time period t, e_{RPH}^{t} is a fuzzy number of the triangular fuzzy set of the collection error of the electricity quantity demand quantity of the photovoltaic units in the time period t, and E[ ] is to obtain a desired value for [ ].

In some embodiments of present disclosure, the second acquisition unit includes a fourth determining module. In the process of acquiring the third total information loss value, the fourth determining module is arranged for determining an information loss value of the market trading caused by the collection error of the electricity quantity trading quotation of the photovoltaic units which participate in the market competition according to

$${L}_{RpH} = {\sum }_{t = 1}^{{N}_{e}} {k}_{p W}^{t} {k}_{pI}^{t} E [ {e}_{Rp}^{t} ] \times E [ {e}_{RpH}^{t} ] ;$$

where Nₑ is the total number of time periods, L_{RpH} is an information loss value of the market trading caused by the collection error of the electricity quantity trading quotation of the photovoltaic units which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, k_{pI}^{t} is a triangular fuzzy set of a collection error of an energy market trading price in the time period t, e_{RpH}^{t} is a fuzzy number of the triangular fuzzy set of the collection error of the energy market trading price of the photovoltaic units in the time period t, and E[ ] is to obtain a desired value for [ ].

In some embodiments of present disclosure, the processing unit includes a first processing module, a second processing module and a third processing module. The first processing module is arranged for, in response to the trust degree being smaller than a first trust degree threshold, executing the third processing mode. The second processing module is arranged for, in response to the trust degree being greater than or equal to the first trust degree threshold and the trust degree being smaller than a second trust degree threshold, executing the second processing mode. The third processing module is arranged for, in response to the trust degree being greater than or equal to the second trust degree threshold, executing the first processing mode.

In some embodiments of present disclosure, the processing unit includes a fifth determining module. The fifth determining module is arranged for determining the trust degree according to

$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$

where B₁ is the trust degree, R_{RP1} is the first information gain value, R_{RP2} is the second information gain value, L_{R} is the first total information loss value, L_{RP} is the second total information loss value, and L_{Rp} is the third total information loss value.

The apparatus for security access to power Internet of Things includes a processor and a memory, where the first acquisition unit, the second acquisition unit, the processing unit, and the like are all stored in the memory as program units. And the processor is arranged for executing the program units stored in the memory to implement corresponding functions. The foregoing modules are all located in the same processor, or the foregoing modules are located in different processors in any combination form.

The processor includes a kernel, and the kernel removes a corresponding program unit from the memory. At least one kernel may be set, and the kernel parameter is adjusted to solve the problem that the effect of controlling whether the generator sets are connected with the Internet of Things is poor due to the fact that the gain value and the loss value are not considered in the control of whether the generator sets are connected with the Internet of Things in the current algorithms.

The memory may include a non-persistent memory, a random access memory (RAM), or a non-transitory memory in a non-transitory medium, for example, a read-only memory (ROM) or a flash memory (flash RAM), and the memory includes at least one storage chip.

Some embodiments of the present disclosure provide a non-transitory storage medium, where the non-transitory storage medium includes a program, where when the program runs, an apparatus where the non-transitory storage medium is located is controlled to execute the method for security access to power Internet of Things.

Some embodiments of the present disclosure provide a processor, where the processor is arranged for running a program, and when the program runs, the method for security access to power Internet of Things is executed.

Some embodiments of the present disclosure provide a device, including a processor, a memory, and a program stored in the memory and executable on the processor, where the processor implements at least the following steps when executing the program: acquiring a first information gain value and a second information gain value by using a fuzzy set method, where the first information gain value is an information gain value, in a market trading, of the power Internet of Things affected by intermittency and variability of sunlight, and the second information gain value is an information gain value, in the market trading, of the power Internet of Things affected by intermittency and variability of wind energy; acquiring a first total information loss value, a second total information loss value and a third total information loss value, where the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things, the second total information loss value is a total information loss value of the market trading caused by a collection error of the electricity quantity trading response quantity of the photovoltaic units and the wind turbine generator sets which participate in the market competition, and the third total information loss value is a total information loss value of the market trading caused by a collection error of the electricity quantity trading quotation of the photovoltaic units and the wind turbine generator sets which participate in the market competition; and determining a trust degree according to the first information gain value, the second information gain value, the first total information loss value, the second total information loss value, and the third total information loss value, and executing one of the following according to a range where the trust degree is located: a first processing mode, a second processing mode and a third processing mode, where the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things. The device herein may be a server, a PC, a PAD, a mobile phone, or the like.

Optionally, acquiring the first information gain value and the second information gain value by using the fuzzy set method includes:
according to

$${R}_{RP 1} = E [ {⋁}_{i = 1}^{9} {k}_{Dvi} {v}_{Dvi} ⊗ {⋁}_{i = 1}^{9} {k}_{Dsi} {S}_{Di} ⊗ {k}_{Mi} ( {M}_{PV} + {M}_{W} ) ]$$

$$- {k}_{G 1} {e}_{G 1} E [ ( {e}_{GPPV}^{t} + {e}_{GPW}^{t} ) ] , \\ {R}_{RP 2} = E [ {⋁}_{i = 1}^{9} {k}_{Dvi} {v}_{Dvi} ⊗ {⋁}_{i = 1}^{9} {k}_{Dsi} {S}_{Di} ⊗ {k}_{Mi} ( {M}_{PV} + {M}_{W} ) ]$$

$$and - {k}_{G 2} {e}_{G 2} E [ ( {e}_{GPPV}^{t} + {e}_{GPW}^{t} ) ] ,$$

determining the first information gain value and the second information gain value;
where R_{RP1} is the first information gain value, R_{RP2} is the second information gain value,

$${⋁}_{i = 1}^{9} {k}_{Dvi} {v}_{Dvi}$$

is an information gain value formed by providing a user with nine fuzzy uncertainty rates, containing extremely low, very low, low, lower, medium, higher, high, very high, and extremely high, for data transmission,

$${⋁}_{i = 1}^{9} {k}_{DSi} {S}_{Di}$$

is an information gain value formed by providing the user with nine fuzzy uncertainty scales, containing extremely low, very low, low, lower, medium, higher, high, very high, and extremely high, for data storage sharing, k_{Mi}M_{PV} is an information gain value formed in response to the power Internet of Things providing data collection for the photovoltaic units at a sensing layer, k_{Mi}M_{W} is an information gain value formed in response to the power Internet of Things providing data collection for the wind turbine generator sets at the sensing layer, E[ ] is to obtain a desired value for [ ], k_{G1} and k_{G2} are respectively information effect coefficients brought about to the user due to power generation errors caused by the effects of intermittency and variability of sunlight and wind energy, e_{G1} and e_{G2} are respectively unit information gain values brought about to the user due to power generation errors caused by the effects of intermittency and variability of sunlight and wind energy, e_{GPPV}^{t} is a triangular fuzzy set of power generation errors of the photovoltaic units caused by uncertainties of sunlight and wind energy in a time period t, and e_{GPW}^{t} is a triangular fuzzy set of power generation errors of the wind turbine generator sets caused by uncertainties of sunlight and wind energy in the time period t, and

$${⋁}_{i = 1}^{9}$$

represents a union set of 9 fuzzy sets.

Optionally, acquiring the first total information loss value includes:
determining the first total information loss value according to

$${L}_{R} = {\sum }_{t = 1}^{{N}_{e}} ( {k}_{PW}^{t} {k}_{PI}^{t} {e}_{P}^{t} + {k}_{pW}^{t} {k}_{pI}^{t} {e}_{p}^{t} ) ;$$

where L_{R} is the first total information loss value, Nₑ is the total number of time periods, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, e_{P}^{t} is an error of the electricity quantity trading quotation of the photovoltaic units and the wind turbine generator sets which participate in the market competition, and eₚ^{t} is a quotation collection error of the photovoltaic units and the wind turbine generator sets which participate in the market competition.

Optionally, in the process of acquiring the second total information loss value, the method further includes:
according to

$${L}_{RPH} = {\sum }_{t = 1}^{{N}_{e}} {k}_{PW}^{t} {k}_{PI}^{t} E [ {e}_{RP}^{t} ] \times E [ {e}_{RPH}^{t} ] ,$$

determining an information loss value of the market trading caused by the collection error of the electricity quantity trading response quantity of the photovoltaic units which participate in the market competition;
where Nₑ is the total number of time periods, L_{RPH} is an information loss value of the market trading caused by the collection error of the electricity quantity trading response quantity of the photovoltaic units which participate in the market competition, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, e_{RP}^{t} is a triangular fuzzy set of the collection error of an electricity quantity demand quantity in the time period t, e_{RPH}^{t} is a fuzzy number of the triangular fuzzy set of the collection error of the electricity quantity demand quantity of the photovoltaic units in the time period t, and E[ ] is to obtain a desired value for [ ].

Optionally, in the process of acquiring the third total information loss value, the method further includes:
according to

$${L}_{RpH} = {\sum }_{t = 1}^{{N}_{e}} {k}_{pW}^{t} {k}_{pI}^{t} E [ {e}_{Rp}^{t} ] \times E [ {e}_{RpH}^{t} ] ,$$

determining an information loss value of the market trading caused by the collection error of the electricity quantity trading quotation of the photovoltaic units which participate in the market competition;
where Nₑ is the total number of time periods, L_{RpH} is an information loss value of the market trading caused by the collection error of the electricity quantity trading quotation of the photovoltaic units which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, e_{Rp}^{t} is a triangular fuzzy set of a collection error of an energy market trading price in the time period t, e_{RpH}^{t} is a fuzzy number of the triangular fuzzy set of the collection error of the energy market trading price of the photovoltaic units in the time period t, and E[ ] is to obtain a desired value for [ ].

Optionally, executing one of the following according to the range where the trust degree is located: the first processing mode, the second processing mode and the third processing mode, includes: in response to the trust degree being smaller than a first trust degree threshold, executing the third processing mode; in response to the trust degree being greater than or equal to the first trust degree threshold and the trust degree being smaller than a second trust degree threshold, executing the second processing mode; and in response to the trust degree being greater than or equal to the second trust degree threshold, executing the first processing mode.

Optionally, determining the trust degree according to the first information gain value, the second information gain value, the first total information loss value, the second total information loss value, and the third total information loss value includes:
determining the trust degree according to

$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$

where B₁ is the trust degree, R_{RP1} is the first information gain value, R_{RP2} is the second information gain value, L_{R} is the first total information loss value, L_{RP} is the second total information loss value, and L_{Rp} is the third total information loss value.

Some embodiments of the present disclosure further provide a computer program product. When executed on a data processing device, the computer program product is adapted to execute a program initialized with at least the following method steps: acquiring a first information gain value and a second information gain value by using a fuzzy set method, where the first information gain value is an information gain value, in a market trading, of the power Internet of Things affected by intermittency and variability of sunlight, and the second information gain value is an information gain value, in the market trading, of the power Internet of Things affected by intermittency and variability of wind energy; acquiring a first total information loss value, a second total information loss value and a third total information loss value, where the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things, the second total information loss value is a total information loss value of the market trading caused by a collection error of the electricity quantity trading response quantity of the photovoltaic units and the wind turbine generator sets which participate in the market competition, and the third total information loss value is a total information loss value of the market trading caused by a collection error of the electricity quantity trading quotation of the photovoltaic units and the wind turbine generator sets which participate in the market competition; and determining a trust degree according to the first information gain value, the second information gain value, the first total information loss value, the second total information loss value, and the third total information loss value, and executing one of the following according to a range where the trust degree is located: a first processing mode, a second processing mode and a third processing mode, where the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things.

Optionally, acquiring the first information gain value and the second information gain value by using the fuzzy set method includes:
according to

$${R}_{RP 1} = E [ {⋁}_{i = 1}^{9} {k}_{Dvi} {v}_{Dvi} ⊗ {⋁}_{i = 1}^{9} {k}_{DSi} {S}_{Di} ⊗ {k}_{Mi} ( {M}_{PV} + {M}_{W} ) ]$$

$$- {k}_{G 1} {e}_{G 1} E [ ( {e}_{GPPV}^{t} + {e}_{GPW}^{t} ) ] , \\ {R}_{RP 2} = E [ {⋁}_{i = 1}^{9} {k}_{Dvi} {v}_{Dvi} ⊗ {⋁}_{i = 1}^{9} {k}_{DSi} {S}_{Di} ⊗ {k}_{Mi} ( {M}_{PV} + {M}_{W} ) ] and \\ - {k}_{G 2} {e}_{G 2} E [ ( {e}_{GPPV}^{t} + {e}_{GPW}^{t} ) ] ,$$

determining the first information gain value and the second information gain value;
where R_{RP1} is the first information gain value, R_{RP2} is the second information gain value,

$${⋁}_{i = 1}^{9} {k}_{Dvi} {v}_{Dvi}$$

is an information gain value formed by providing a user with nine fuzzy uncertainty rates, containing extremely low, very low, low, lower, medium, higher, high, very high, and extremely high, for data transmission,

$${⋁}_{i = 1}^{9} {k}_{Dsi} {S}_{Di}$$

is an information gain value formed by providing the user with nine fuzzy uncertainty scales, containing extremely low, very low, low, lower, medium, higher, high, very high, and extremely high, for data storage sharing, k_{Mi}M_{PV} is an information gain value formed in response to the power Internet of Things providing data collection for the photovoltaic units at a sensing layer, k_{Mi}M_{W} is an information gain value formed in response to the power Internet of Things providing data collection for the wind turbine generator sets at the sensing layer, E[ ] is to obtain a desired value for [ ], k_{G1} and k_{G2} are respectively information effect coefficients brought about to the user due to power generation errors caused by the effects of intermittency and variability of sunlight and wind energy, e_{G1} and e_{G2} are respectively unit information gain values brought about to the user due to power generation errors caused by the effects of intermittency and variability of sunlight and wind energy, e_{GPPV}^{t} is a triangular fuzzy set of power generation errors of the photovoltaic units caused by uncertainties of sunlight and wind energy in a time period t, and e_{GPW}^{t} is a triangular fuzzy set of power generation errors of the wind turbine generator sets caused by uncertainties of sunlight and wind energy in the time period t, and

$${⋁}_{i = 1}^{9}$$

represents a union set of 9 fuzzy sets.

Optionally, acquiring the first total information loss value includes:
determining the first total information loss value according to

$${L}_{R} = {\sum }_{t = 1}^{{N}_{e}} ( {k}_{PW}^{t} {k}_{PI}^{t} {e}_{P}^{t} + {k}_{pW}^{t} {k}_{pI}^{t} {e}_{p}^{t} ) ;$$

where L_{R} is the first total information loss value, Nₑ is the total number of time periods, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, e_{P}^{t} is an error of the electricity quantity trading quotation of the photovoltaic units and the wind turbine generator sets which participate in the market competition, and eₚ^{t} is a quotation collection error of the photovoltaic units and the wind turbine generator sets which participate in the market competition.

Optionally, in the process of acquiring the second total information loss value, the method further includes:
according to

$${L}_{RPH} = {\sum }_{t = 1}^{{N}_{e}} {k}_{PW}^{t} {k}_{PI}^{t} E [ {e}_{RP}^{t} ] \times E [ {e}_{RPH}^{t} ] ,$$

determining an information loss value of the market trading caused by the collection error of the electricity quantity trading response quantity of the photovoltaic units which participate in the market competition;
where Nₑ is the total number of time periods, L_{RPH} is an information loss value of the market trading caused by the collection error of the electricity quantity trading response quantity of the photovoltaic units which participate in the market competition, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, e_{RP}^{t} is a triangular fuzzy set of the collection error of an electricity quantity demand quantity in the time period t, e_{RPH}^{t} is a fuzzy number of the triangular fuzzy set of the collection error of the electricity quantity demand quantity of the photovoltaic units in the time period t, and E[ ] is to obtain a desired value for [ ].

Optionally, in the process of acquiring the third total information loss value, the method further includes:
according to

$${L}_{RpH} = {\sum }_{t = 1}^{{N}_{e}} {k}_{pW}^{t} {k}_{pI}^{t} E [ {e}_{Rp}^{t} ] \times E [ {e}_{RpH}^{t} ] ,$$

determining an information loss value of the market trading caused by the collection error of the electricity quantity trading quotation of the photovoltaic units which participate in the market competition;
where Nₑ is the total number of time periods, L_{RpH} is an information loss value of the market trading caused by the collection error of the electricity quantity trading quotation of the photovoltaic units which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, e_{Rp}^{t} is a triangular fuzzy set of a collection error of an energy market trading price in the time period t, E_{RpH}^{t} is a fuzzy number of the triangular fuzzy set of the collection error of the energy market trading price of the photovoltaic units in the time period t, and E[ ] is to obtain a desired value for [ ].

Optionally, executing one of the following according to the range where the trust degree is located: the first processing mode, the second processing mode and the third processing mode, includes: in response to the trust degree being smaller than a first trust degree threshold, executing the third processing mode; in response to the trust degree being greater than or equal to the first trust degree threshold and the trust degree being smaller than a second trust degree threshold, executing the second processing mode; and in response to the trust degree being greater than or equal to the second trust degree threshold, executing the first processing mode.

Optionally, determining the trust degree according to the first information gain value, the second information gain value, the first total information loss value, the second total information loss value, and the third total information loss value includes:
determining the trust degree according to

$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$

where Bₜ is the trust degree, R_{RP1} is the first information gain value, R_{RP2} is the second information gain value, L_{R} is the first total information loss value, L_{RP} is the second total information loss value, and L_{Rp} is the third total information loss value.

Some embodiments of the present disclosure further provide a system for security access to power Internet of Things, the system includes: at least one processor, a memory and at least one program, where at least one program is stored in the memory and arranged for being executed by at least one processor, and at least one program includes computer instructions of the method for security access to power Internet of Things. The power Internet of Things trust degree oriented to the market trading can be calculated and used as a criterion for Internet of Things security access control, and this method for security access control to the Internet of Things oriented to the distributed energy transaction can reflect the influence of the sensing system, the data transmission rate, and the data storage sharing at the same time, and can further provide a theoretical guidance for the evaluation of the power Internet of Things trust degree oriented to the market trading, and provide the necessary technical support for the market trading based on the Internet of Things. At the same time, due to the consideration of the gain value as well as the loss value, solves the problem that the effect of controlling whether the generator sets are connected with the Internet of Things is poor due to the fact that the gain value and the loss value are not considered in the control of whether the generator sets are connected with the Internet of Things in the current algorithms.

It should be apparent to those skilled person in the art that the various modules or steps of the present disclosure can be implemented by a general-purpose computing device, and the various modules or steps can be concentrated on a single computing device or distributed on a network composed of multiple computing devices, and the various modules or steps can be stored in a storage device for execution by the computing device, and in some cases, the steps shown or described can be performed in an order different from that described herein, or can be fabricated into individual integrated circuit modules, or multiple modules or steps in the integrated circuit modules can be fabricated into a single integrated circuit module. In this way, the present disclosure is not limited to any specific combination of hardware and software.

Those skilled person in the art should understand that the embodiments of present disclosure can be provided as a method, a system, or a computer program product. Therefore, the present disclosure may use a form of hardware embodiments, software embodiments, or embodiments with a combination of software and hardware. Moreover, the present disclosure may use a form of a computer program product implemented on at least one computer-usable storage media (including but not limited to a disk memory, a CD-ROM, an optical memory, and the like) including computer-usable program codes.

The present disclosure is described with reference to the flowcharts and/or block diagrams of the method, the device (system), and the computer program product according to the embodiments of present disclosure. It should be understood that computer program instructions can be used for implementing each process and/or block in the flowcharts and/or the block diagrams and a combination of a process and/or a block in the flowcharts and/or the block diagrams. These computer program instructions can be provided to a general-purpose computer, a special-purpose computer, an embedded processor, or a processor of another programmable data processing device to generate a machine, so that the instructions executed by the processor of the computer or other programmable data processing devices generate an apparatus for implementing the functions specified in at least one flow of the flowcharts and/or at least one block in the block diagrams.

These computer program instructions may also be stored in a computer-readable memory capable of guiding a computer or other programmable data processing devices to operate in a specific manner, so that the instructions stored in the computer-readable memory produce an article of manufacture including an instruction apparatus that implements the functions specified in at least one flow of the flowchart and/or at least one block of the block diagram.

These computer program instructions may also be loaded onto a computer or other programmable data processing device such that a series of operational steps are performed on the computer or other programmable device to produce a computer-implemented process, such that the instructions executed on the computer or other programmable device provide steps for implementing the functions specified in at least one flow of the flowchart and/or at least one block of the block diagram.

In one typical configuration, a computing device includes at least one processor (such as CPU), input/output interface, network interface, and memory.

The memory may include a non-persistent memory, a random access memory (RAM), and/or a non-transitory memory in a computer-readable medium, for example, a read-only memory (ROM) or a flash RAM. The memory is an example of a computer-readable medium.

The computer-readable medium includes persistent, non-persistent, movable, and non-removable media that can store information by using any method or technology. The information can be a computer-readable instruction, a data structure, a program module, or other data. Examples of computer storage media include, but are not limited to, phase-change random access memory (PRAM), static random access memory (SRAM), dynamic random access memory (DRAM), other types of random access memory (RAM), read only memory (ROM), electrically erasable programmable read only memory (EEPROM), flash memory or other memory technology, read only optical disk read only memory (CD-ROM), digital versatile disk (DVD), or other optical storage, magnetic cassettes, magnetic tape, magnetic disk storage or other magnetic storage devices, or any other non-transmission medium, can be used for storing information that can be accessed by a computing device. As defined herein, the computer-readable medium does not include transitory media, such as a modulated data signal and a carrier.

It should also be noted that the terms “comprising”, “including” or any other variation thereof are intended to cover a non-exclusive inclusion, so that a process, method, commodity, or device that includes a series of elements includes not only those elements, but also other elements that are not explicitly listed, or elements inherent to such a process, method, commodity, or device. In the absence of more restrictions, the statement” includes one. There are no additional identical elements in the process, method, product, or device that includes the element.

From the above description, it can be seen that the above embodiments of the present disclosure achieve the following technical effects.

Through the method for security access to power Internet of Things in some embodiments of the present disclosure, the power Internet of Things trust degree oriented to the market trading can be calculated and used as a criterion for Internet of Things security access control, and this method for security access control to the Internet of Things oriented to the distributed energy transaction can reflect the influence of the sensing system, the data transmission rate, and the data storage sharing at the same time, and can further provide a theoretical guidance for the evaluation of the power Internet of Things trust degree oriented to the market trading, and provide the necessary technical support for the market trading based on the Internet of Things. At the same time, due to the consideration of the gain value as well as the loss value, solves the problem that the effect of controlling whether the generator sets are connected with the Internet of Things is poor due to the fact that the gain value and the loss value are not considered in the control of whether the generator sets are connected with the Internet of Things in the current algorithms.

Through the apparatus for security access to power Internet of Things in some embodiments of the present disclosure, the power Internet of Things trust degree oriented to the market trading can be calculated and used as a criterion for Internet of Things security access control, and this method for security access control to the Internet of Things oriented to the distributed energy transaction can reflect the influence of the sensing system, the data transmission rate, and the data storage sharing at the same time, and can further provide a theoretical guidance for the evaluation of the power Internet of Things trust degree oriented to the market trading, and provide the necessary technical support for the market trading based on the Internet of Things. At the same time, due to the consideration of the gain value as well as the loss value, solves the problem that the effect of controlling whether the generator sets are connected with the Internet of Things is poor due to the fact that the gain value and the loss value are not considered in the control of whether the generator sets are connected with the Internet of Things in the current algorithms.

The descriptions are exemplary embodiments of present disclosure and are not intended to limit present disclosure, and for those skilled person in the art, the present disclosure may have various changes and changes. Any modification, equivalent replacement, or improvement made within the spirit and principle of present disclosure shall fall within the protection scope of present disclosure.

What is claimed is:

1. A method for security access to power Internet of Things, wherein the method is applicable to photovoltaic units and wind turbine generator sets, the method comprising:
acquiring a first information gain value and a second information gain value by using a fuzzy set method, wherein the first information gain value is an information gain value, in a market trading, of the power Internet of Things affected by intermittency and variability of sunlight, and the second information gain value is an information gain value, in the market trading, of the power Internet of Things affected by intermittency and variability of wind energy;
acquiring a first total information loss value, a second total information loss value and a third total information loss value, wherein the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things, the second total information loss value is a total information loss value of the market trading caused by a collection error of the electricity quantity trading response quantity of the photovoltaic units and the wind turbine generator sets which participate in the market competition, and the third total information loss value is a total information loss value of the market trading caused by a collection error of the electricity quantity trading quotation of the photovoltaic units and the wind turbine generator sets which participate in the market competition; and
determining a trust degree according to the first information gain value, the second information gain value, the first total information loss value, the second total information loss value, and the third total information loss value, and executing one of the following according to a range where the trust degree is located: a first processing mode, a second processing mode and a third processing mode, wherein the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things.

2. The method as claimed in claim 1, wherein acquiring the first information gain value and the second information gain value by using the fuzzy set method comprises:
$${R}_{RP 1} = E [ {{⋁}_{i = 1}}^{9} {k}_{Dvi} {v}_{Dvi} ⊗ {{⋁}_{i = 1}}^{9} {k}_{DSi} {S}_{Di} ⊗ {k}_{Mi} ( {M}_{PV} + {M}_{W} ) ]$$
according to
$$- {k}_{G 1} {e}_{G 1} E [ ( {e}_{GPPV}^{t} + {e}_{GPW}^{t} ) ] ,$$
$${R}_{RP 2} = E [ {{⋁}_{i = 1}}^{9} {k}_{Dvi} {v}_{Dvi} ⊗ {{⋁}_{i = 1}}^{9} {k}_{DSi} {S}_{Di} ⊗ {k}_{Mi} ( {M}_{PV} + {M}_{W} ) ]$$
$$and - {k}_{G 2} {e}_{G 2} E [ ( {e}_{GPPV}^{t} + {e}_{GPW}^{t} ) ] ,$$
determining the first information gain value and the second information gain value;
wherein R_{RP1} is the first information gain value, R_{RP2} is the second information gain value,
$${{⋁}_{i = 1}}^{9} {k}_{Dvi} {v}_{Dvi}$$
is an information gain value formed by providing a user with nine fuzzy uncertainty rates, containing extremely low, very low, low, lower, medium, higher, high, very high, and extremely high, for data transmission,
$${{⋁}_{i = 1}}^{9} {k}_{DSi} {S}_{Di}$$
is an information gain value formed by providing the user with nine fuzzy uncertainty scales, containing extremely low, very low, low, lower, medium, higher, high, very high, and extremely high, for data storage sharing, k_{Mi}M_{PV} is an information gain value formed in response to the power Internet of Things providing data collection for the photovoltaic units at a sensing layer, k_{Mi}M_{W} is an information gain value formed in response to the power Internet of Things providing data collection for the wind turbine generator sets at the sensing layer, E[ ] is to obtain a desired value for [ ], k_{G1} and k_{G2} are respectively information effect coefficients brought about to the user due to power generation errors caused by the effects of intermittency and variability of sunlight and wind energy, e_{G1} and e_{G2} are respectively unit information gain values brought about to the user due to power generation errors caused by the effects of intermittency and variability of sunlight and wind energy, e_{GPPV}^{t} is a triangular fuzzy set of power generation errors of the photovoltaic units caused by uncertainties of sunlight and wind energy in a time period t, and e_{GPW}^{t} is a triangular fuzzy set of power generation errors of the wind turbine generator sets caused by uncertainties of sunlight and wind energy in the time period t, and
$${{⋁}_{i = 1}}^{9}$$
represents a union set of 9 fuzzy sets.

3. The method as claimed in claim 1, wherein acquiring the first total information loss value comprises:
determining the first total information loss value according to
$${L}_{R} = {\sum }_{t = 1}^{{N}_{e}} ( {k}_{PW}^{t} {k}_{PI}^{t} {e}_{P}^{t} + {k}_{p W}^{t} {k}_{pI}^{t} {e}_{p}^{t} ) ;$$
wherein L_{R} is the first total information loss value, Nₑ is the total number of time periods, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, e_{P}^{t} is an error of the electricity quantity trading quotation of the photovoltaic units and the wind turbine generator sets which participate in the market competition, and eₚ^{t} is a quotation collection error of the photovoltaic units and the wind turbine generator sets which participate in the market competition.

4. The method as claimed in claim 1, wherein in a process of acquiring the second total information loss value, the method further comprises:
according to
$${L}_{RPH} = {\sum }_{t = 1}^{{N}_{e}} {k}_{PW}^{t} {k}_{PI}^{t} E [ {e}_{RP}^{t} ] \times E [ {e}_{RPH}^{t} ] ,$$
determining an information loss value of the market trading caused by the collection error of the electricity quantity trading response quantity of the photovoltaic units which participate in the market competition,
wherein Nₑ is the total number of time periods, L_{RPH} is an information loss value of the market trading caused by the collection error of the electricity quantity trading response quantity of the photovoltaic units which participate in the market competition, k_{PW}^{t} is a weight coefficient of the collection error of the electricity quantity trading response quantity of the photovoltaic units and the wind turbine generator sets which participate in the market competition, k_{PI}^{t} is a unit loss value brought about by the collection error of the electricity quantity trading response quantity of the photovoltaic units and the wind turbine generator sets which participate in the market competition, e_{RP}^{t} is a triangular fuzzy set of the collection error of an electricity quantity demand quantity in the time period t, e_{RPH}^{t} is a fuzzy number of the triangular fuzzy set of the collection error of the electricity quantity demand quantity of the photovoltaic units in the time period t, and E[ ] is to obtain a desired value for [ ].

5. The method as claimed in claim 1, wherein in a process of acquiring the third total information loss value, the method further comprises:
according to
$${L}_{RpH} = {\sum }_{t = 1}^{{N}_{e}} {k}_{p W}^{t} {k}_{pI}^{t} E [ {e}_{Rp}^{t} ] \times E [ {e}_{RpH}^{t} ] ,$$
determining an information loss value of the market trading caused by the collection error of the electricity quantity trading quotation of the photovoltaic units which participate in the market competition,
wherein Nₑ is the total number of time periods, L_{RpH} is an information loss value of the market trading caused by the collection error of the electricity quantity trading quotation of the photovoltaic units which participate in the market competition, k_{pW}^{t} is a weight coefficient of a quotation collection error of the photovoltaic units and the wind turbine generator sets which participate in the market competition, k_{pI}^{t} is a unit loss value of the electricity quantity trading quotation of the photovoltaic units and the wind turbine generator sets which participate in the market competition, e_{Rp}^{t} is a triangular fuzzy set of a collection error of an energy market trading price in the time period t, e_{RpH}^{t} is a fuzzy number of the triangular fuzzy set of the collection error of the energy market trading price of the photovoltaic units in the time period t, and E[ ] is to obtain a desired value for [ ].

6. The method as claimed in claim 1, wherein executing one of the following according to the range where the trust degree is located: the first processing mode, the second processing mode and the third processing mode, comprises:
in response to the trust degree being smaller than a first trust degree threshold, executing the third processing mode;
in response to the trust degree being greater than or equal to the first trust degree threshold and the trust degree being smaller than a second trust degree threshold, executing the second processing mode; and
in response to the trust degree being greater than or equal to the second trust degree threshold, executing the first processing mode.

7. The method as claimed in claim 1, wherein determining the trust degree according to the first information gain value, the second information gain value, the first total information loss value, the second total information loss value, and the third total information loss value comprises:
determining the trust degree according to
$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$
wherein B₁ is the trust degree, R_{RP1} is the first information gain value, R_{RP2} is the second information gain value, L_{R} is the first total information loss value, L_{RP} is the second total information loss value, and L_{Rp} is the third total information loss value.

8. The method as claimed in claim 2, wherein determining the trust degree according to the first information gain value, the second information gain value, the first total information loss value, the second total information loss value, and the third total information loss value comprises:
determining the trust degree according to
$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$
wherein B₁ is the trust degree, R_{RP1} is the first information gain value, R_{RP2} is the second information gain value, L_{R} is the first total information loss value, L_{RP} is the second total information loss value, and L_{Rp} is the third total information loss value.

9. The method as claimed in claim 3, wherein determining the trust degree according to the first information gain value, the second information gain value, the first total information loss value, the second total information loss value, and the third total information loss value comprises:
determining the trust degree according to
$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$
wherein B₁ is the trust degree, R_{RP1} is the first information gain value, R_{RP2} is the second information gain value, L_{R} is the first total information loss value, L_{RP} is the second total information loss value, and L_{Rp} is the third total information loss value.

10. The method as claimed in claim 4, wherein determining the trust degree according to the first information gain value, the second information gain value, the first total information loss value, the second total information loss value, and the third total information loss value comprises:
determining the trust degree according to
$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$
wherein B₁ is the trust degree, R_{RP1} is the first information gain value, R_{RP2} is the second information gain value, L_{R} is the first total information loss value, L_{RP} is the second total information loss value, and L_{Rp} is the third total information loss value.

11. The method as claimed in claim 5, wherein determining the trust degree according to the first information gain value, the second information gain value, the first total information loss value, the second total information loss value, and the third total information loss value comprises:
determining the trust degree according to
$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$
wherein B₁ is the trust degree, R_{RP1} is the first information gain value, R_{RP2} is the second information gain value, L_{R} is the first total information loss value, L_{RP} is the second total information loss value, and R_{Rp} is the third total information loss value.

12. The method as claimed in claim 6, wherein determining the trust degree according to the first information gain value, the second information gain value, the first total information loss value, the second total information loss value, and the third total information loss value comprises:
determining the trust degree according to
$${B}_{1} = \frac{min ( {R}_{RP 1} , {R}_{RP 2} )}{max ( {R}_{RP 1} , {R}_{RP 2} ) + max ( {L}_{R} , {L}_{RP} + {L}_{Rp} )} ,$$
wherein B₁ is the trust degree, R_{RP1} is the first information gain value, R_{RP2} is the second information gain value, L_{R} is the first total information loss value, L_{RP} is the second total information loss value, and L_{Rp} is the third total information loss value.

13. A non-transitory storage medium, wherein the non-transitory storage medium comprises a program, wherein when the program runs, a device where the non-transitory storage medium is located is controlled to execute:
acquiring a first information gain value and a second information gain value by using a fuzzy set method, wherein the first information gain value is an information gain value, in a market trading, of the power Internet of Things affected by intermittency and variability of sunlight, and the second information gain value is an information gain value, in the market trading, of the power Internet of Things affected by intermittency and variability of wind energy;
acquiring a first total information loss value, a second total information loss value and a third total information loss value, wherein the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things; the second total information loss value is a total information loss value of the market trading caused by a collection error of the electricity quantity trading response quantity of the photovoltaic units and the wind turbine generator sets which participate in the market competition; and the third total information loss value is a total information loss value of the market trading caused by a collection error of the electricity quantity trading quotation of the photovoltaic units and the wind turbine generator sets which participate in the market competition; and
determining a trust degree according to the first information gain value, the second information gain value, the first total information loss value, the second total information loss value, and the third total information loss value, and executing one of the following according to a range where the trust degree is located: a first processing mode, a second processing mode and a third processing mode, wherein the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things.

14. A system for security access to power Internet of Things, comprising: at least one processor, a memory and at least one program, wherein the at least one program is stored in the memory and arranged to being executed by the at least one processor, and the at least one program comprise computer instructions of the method for security access to power Internet of Things for executing:
acquiring a first information gain value and a second information gain value by using a fuzzy set method, wherein the first information gain value is an information gain value, in a market trading, of the power Internet of Things affected by intermittency and variability of sunlight, and the second information gain value is an information gain value, in the market trading, of the power Internet of Things affected by intermittency and variability of wind energy;
acquiring a first total information loss value, a second total information loss value and a third total information loss value, wherein the first total information loss value is a total information loss value in the market trading caused by collection errors of an electricity quantity trading response quantity and an electricity quantity trading quotation of photovoltaic units and wind turbine generator sets which participate in market competition and are formed in the power Internet of Things; the second total information loss value is a total information loss value of the market trading caused by a collection error of the electricity quantity trading response quantity of the photovoltaic units and the wind turbine generator sets which participate in the market competition; and the third total information loss value is a total information loss value of the market trading caused by a collection error of the electricity quantity trading quotation of the photovoltaic units and the wind turbine generator sets which participate in the market competition; and
determining a trust degree according to the first information gain value, the second information gain value, the first total information loss value, the second total information loss value, and the third total information loss value, and executing one of the following according to a range where the trust degree is located: a first processing mode, a second processing mode and a third processing mode, wherein the first processing mode is to allow the photovoltaic units and the wind turbine generator sets to access the power Internet of Things, the second processing mode is to allow the photovoltaic units or the wind turbine generator sets to access the power Internet of Things, and the third processing mode is to prohibit the photovoltaic units and the wind turbine generator sets from accessing the power Internet of Things.
